(19) United States
(12) Patent Application Publication
(10) Pub. No.: US 2007/0158211 A1
(43) Pub. Date: Jul. 12, 2007

(54) Arsenic measurement using anodic stripping voltammetry

(75) Inventors: Chang-Dong Feng, Long Beach, CA (US); Joshua Xu, Irvine, CA (US)

Correspondence Address: WESTMAN CHAMPLIN & KELLY, P.A., SUITE 1400, 900 SECOND AVENUE SOUTH, MINNEAPOLIS, MN, 55402-3319, US

(73) Assignee: Rosemount Analytical Inc., Irvine, CA (US)

(21) Appl. No.: 11/650,904

(22) Filed: Jan. 8, 2007

Related U.S. Application Data
(60) Provisional application No. 60/757,458, filed on Jan. 9, 2006.

(51) Int. Cl. G01N 27/26

(52) U.S. Cl. 205/775; 204/400

(57) ABSTRACT

Measurement of arsenic in an aqueous solution is provided. The pH of the aqueous solution is adjusted to a pH of about 7.0 or higher. The pH adjusted aqueous solution is then analyzed using anodic stripping voltammetry to obtain an indication of a quantity of arsenic in the solution. In one aspect, the pH is adjusted using a phosphate buffer.

### CROSS-REFERENCE TO RELATED APPLICATION

The present application is based on and claims the benefit of U.S. provisional patent application Ser. No. 60/757,458, filed Jan. 9, 2006, the content of which is hereby incorporated by reference in its entirety.

### BACKGROUND OF THE INVENTION

Water is the most crucial element needed for human activity on the planet, including agricultural, industrial and domestic use. Unfortunately, water quality around the world is poor and getting worse. While over 70% of the earth is covered in water, only about 0.01% is usable fresh water. And since water demand increases with population, the re-use of water and proper treatment methods have become a critical necessity.

Water is a universal solvent and comes in contact with a vast array of harmful and/or undesirable substances. One of the most dreaded contaminants in drinking water is arsenic. Arsenic appears naturally in soil, water and bedrock. In pure form, arsenic is a silver-gray or white brittle metal. Arsenic is virtually tasteless and has no odor. Consuming less than a teaspoon full of arsenic can generate severe headache, a tired feeling, confusion, hallucinations, diarrhea, vomiting, digestive system bleeding, seizures or a coma. Long term exposure to toxic forms of arsenic are believed to cause various forms of cancer, such as skin, liver or kidney cancer. Additionally, arsenic is known to be harmful to the nervous system.

Accordingly, drinking water systems commonly measure arsenic levels during processing. One promising technique for arsenic measurement is believed to be the known analytical technique for anodic stripping voltammetry (ASV).

Anodic stripping voltammetry is an electrolytic analytical method in which a working electrode, in the case of mercury, is held at a negative potential to reduce metal ions in solution and form an amalgam with the electrode. The solution is stirred, or otherwise agitated, to bring as much of the analyte(s) metal to the working electrode as possible for concentration into the amalgam. After the reduced analyte has accumulated for some selected period of time, the potential on the working electrode is increased to re-oxidize the analyte and generate a current signal. Other electrode materials, such as graphite, glassy carbon, diamond thin film, gold, et cetera can also be used as the working electrode.

The increased potential can be in the form of a step function, such as normal-pulse polarography (NPP) or differential-pulse polarography (DPP). The concentration of the analyte in the working electrode is generally a function of the limiting current measured during the reduction of the metal; the duration of the accumulation; the number of moles of electrons transferred in the half reaction; the Faraday constant (96,487 coulombs/mole of e⁻) and the volume of the electrode. The expression for the current produced by the anodic stripping depends on the particular type of the working electrode, but is generally directly proportional to the concentration of the analyte concentrated into the electrode. One advantage of anodic stripping voltammetry is the pre-concentration of the analyte into the electrode, thereby allowing the method to achieve very, very low detection limits.

In traditional anodic stripping voltammetry, the sample solution is adjusted acidic by adding acid such as hydrochloric acid (HCl), sulfuric acid (H₂SO₄), and/or nitric acid (HNO₃). In this acidic condition, all other metal ions in the sample co-exist in cation form. However, some of the metal ions, such as the copper ion, can interfere with the measurement of arsenic in the anodic stripping voltammetry method. Such interference can reduce the accuracy of such voltammetry methods.

Providing analytical techniques for the accurate measurement of arsenic in drinking water using anodic stripping voltammetry would be beneficial to industries that provide, or otherwise monitor, drinking water supplies for arsenic contamination.

### SUMMARY OF THE INVENTION

Measurement of arsenic in an aqueous solution is provided. The pH of the aqueous solution is adjusted to a pH of about 7.0 or higher. The pH adjusted aqueous solution is then analyzed using anodic stripping voltammetry to obtain an indication of a quantity of arsenic in the solution. In one aspect, the pH is adjusted using a phosphate buffer.

### BRIEF DESCRIPTION OF THE DRAWINGS

FIG. 1 is a diagrammatic view of an arsenic measurement system employing anodic stripping voltammetry in accordance with an embodiment of the present invention.

FIG. 2 is a flow diagram of a method of measuring arsenic in an aqueous sample in accordance with an embodiment of the present invention.

FIG. 3 is a chart illustrating various examples of anodic stripping voltammetry using square wave voltammetry of arsenic (III) in a pH 7 phosphate buffer with a gold working electrode.

### DETAILED DESCRIPTION OF ILLUSTRATIVE EMBODIMENTS

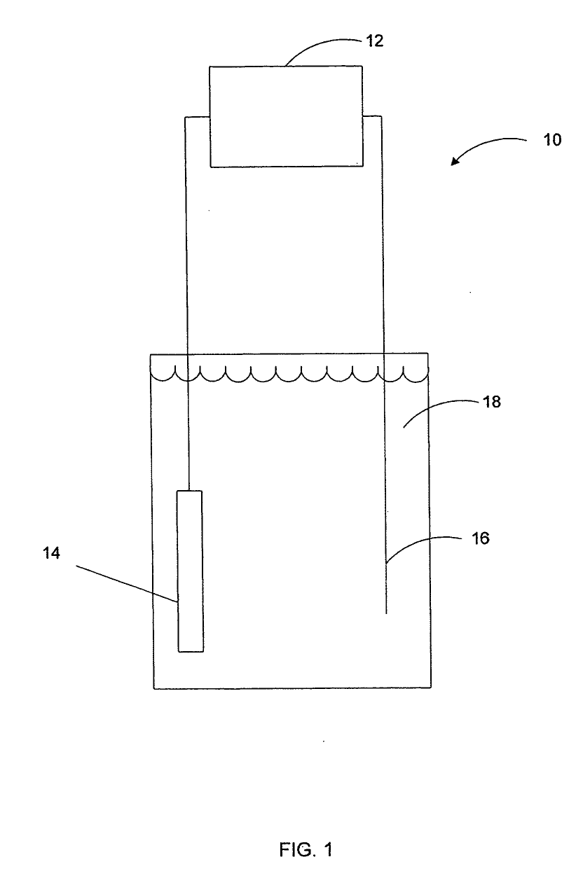

FIG. 1 is a diagrammatic view of an arsenic measurement system employing anodic stripping voltammetry in accordance with an embodiment of the present invention. System 10 includes analyzer 12 coupled to a plurality of electrodes 14, 16 disposed within sample solution 18. Electrode 14 is a working electrode and may be comprised of mercury, or any other suitable metal, such as gold. Sample specimen 18 contains a quantity of arsenic for which quantification is desired. In accordance with embodiments of the present invention, the pH of sample solution 18 is adjusted to approximately 7.0, or higher. This is in distinct contrast to anodic stripping voltammetry methods of the prior art that generally acidify sample solutions by adding acids such as hydrochloric acid, sulfuric acid, or nitric acid. Once the pH of solution 18 has been suitably adjusted, electrode 14 is biased to a negative potential by analyzer 12. The negative potential of working electrode 14 causes the arsenic within solution 18 to accumulate on electrode 14 by virtue of reduction. The working electrode can be formed of any suitable material including, without limitation, gold, graphite, glassy carbon, and diamond thin film. In embodiments where electrode 14 is formed of gold, this accumulation process forms reduced arsenic. Once suitable time has passed, the potential between the plurality of electrodes 14 and 16 is reversed thereby causing oxidation of the arsenic accumulated upon working electrode 14. The current observed during the oxidation process provides information regarding the quantity of arsenic present in solution 18.

Adjustment of the pH of sample solution 18 can be done in any suitable manner. However, the pH is preferably adjusted by utilizing a buffer solution. Preferably, the buffer is a phosphate buffer, but other suitable buffers can be used in accordance with embodiments of the present invention. In addition, other suitable substances can be added to sample solution 18 to form complexes with any interfering metals. For example, chelating ligands 10, can be added to sample solution 18, such as ethylenediaminetetraacetic acid. Adjusting the pH of sample solution 18 to be at or higher than seven facilitates the formation of precipitates and complexes with the interfering metals.

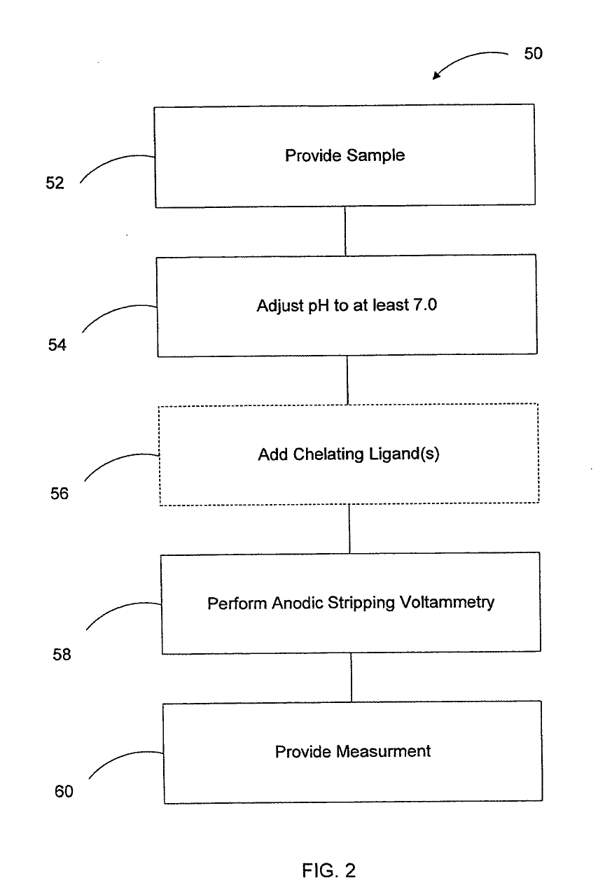

FIG. 2 is a flow diagram of a method of measuring arsenic in an aqueous sample in accordance with an embodiment of the present invention. Method 50 begins at block 52 where the aqueous arsenic-containing sample is provided. Next, at block 54, the pH of the sample is adjusted to equal, or exceed 7.0. Preferably, the pH is adjusted using a buffer solution, such as a phosphate buffer. Further, as indicated at phantom block 56, substances can be added to the sample solution to form complexes with interfering metals. For example, such substances can include chelating ligands, such as ethylenediaminetetraacetic acid. Next, at block 58, anodic stripping voltammetry is performed on the pH-adjusted aqueous sample to determine and/or quantify the presence of arsenic in the sample. At block 60, the measurement is provided.

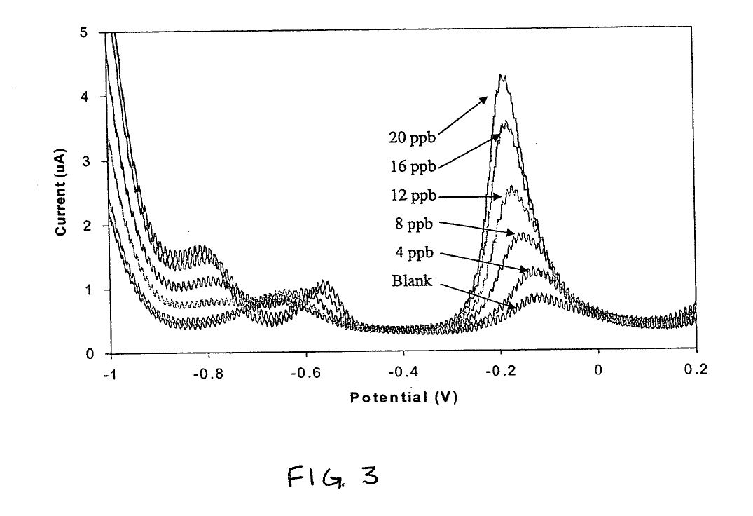

FIG. 3 is a chart illustrating various examples of anodic stripping voltammetry using square wave voltammetry of arsenic (III) in a pH 7 phosphate buffer. The deposition time was 500 seconds. The plot is of the potential versus silver/silver chloride, saturated potassium chloride.

Although the present invention has been described with reference to preferred embodiments, workers skilled in the art will recognize that changes may be made in form and detail without departing from the spirit and scope of the invention.

What is claimed is:

1. A system for quantifying the presence of arsenic in an aqueous sample, the system comprising:
a working electrode configured to contact the sample;
a second electrode configured to contact the sample;
a pH-adjusting material disposed within the aqueous sample, the pH adjusting material configured to adjust the pH to at least about 7.0; and
an analyzer coupled to the working electrode and the second electrode, the analyzer being configured to perform anodic stripping voltammetry on the pH adjusted sample to determine an amount of arsenic in the sample.

2. The system of claim 1, wherein the pH-adjusting material is a buffer.

3. The system of claim 2, wherein the buffer is a phosphate buffer.

4. The system of claim 1, and further comprising an additional additive to the sample, the additive being configured to react with at least one interfering metal.

5. The system of claim 4, wherein the additive is a chelating ligand.

6. The system of claim 5, wherein the chelating ligand is ethylenediaminetetraacetic acid.

7. The system of claim 1, wherein the working electrode is constructed from a material selected from the group consisting of gold, graphite, glassy carbon, and diamond thin film.

8. A method for measuring a quantity of arsenic in an aqueous sample, the method comprising:
adjusting the pH of the aqueous sample to be at least 7.0;
generating a negative potential on a working electrode for a period of time; and
reversing the potential of the working electrode and measuring a current related to the presence of arsenic in the sample.

9. The method of claim 8, wherein adjusting the pH of the aqueous sample includes adding a buffer to the sample.

10. The method of claim 9, wherein the buffer is a phosphate buffer.

11. The method of claim 8, and further comprising adding at least one chelating ligand to the aqueous sample.

12. The method of claim 11, wherein the chelating ligand is ethylenediaminetetraacetic acid.
